(19) United States
(12) Patent Application Publication
(10) Pub. No.: US 2004/0262349 A1
(43) Pub. Date: Dec. 30, 2004

(54) Motorcycle Gas Cap Holder

(76) Inventor: Daniel Joseph Dawson, Sebastopol, CA (US)

Correspondence Address: DANIEL JOSEPH DAWSON - AN INDIVIDUAL, 7050 LYNCH RD., SEBASTOPOL, CA, 95472, US

(21) Appl. No.: 10/249,657

(22) Filed: Jun. 27, 2003

(51) Int. Cl. B62J 9/00; B62J 11/00; B62J 7/00

(52) U.S. Cl. 224/413

(57) ABSTRACT

There is currently no method, article or substitute available from either an OEM or aftermarket company which is made for the purposes decscribed herein and fulfilled by this invention. While the technical means of manufacture are readily available, the use of this particuliar machined aprt is not available. A temporary Motorcycle Gas Cap Holding Device does not currently exist.

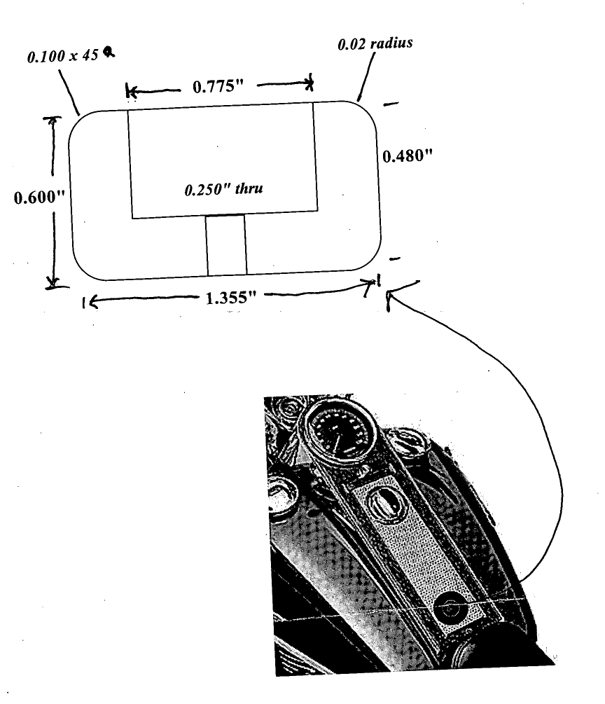

### BRIEF DESCRIPTION OF DRAWINGS

The drawing, 1A, shows the invention from a side elevation and a photo depicting location on a typical motorcycle gas tank dash unit.

### DETAILED DESCRIPTION

The invention is a metal (Aluminum 6061 or substitute material), disc machined using modern CNC (Computer Numerical Control) machining techniques to be used as a holder for the motorcycle's gas cap during refueling. The disc/invention is machined as follows; a 1.5″ round bar of 6061 Aluminum is inserted into the bar feed device of the CNC lathe. The section of bar stock used for one part/holder is 0.600″ in length. The outside diameter is machined to 0.10-0.020″ less than the inside diameter of the gas cap. This diameter can be machined appropriately for any given gas cap inside diameter and in this case the dimension is 1.355″ which is for a 1.375″ inside diameter gas cap. The next machining operation is to drill the center hole used to mount the holder, this thru-hole is 0.250″ diameter. The insert holding diameter is then drilled to accomodate a decorative insert that serves to hide the mounting hardware and to give the device an attractive appearance, this dimension is 0.48″ deep with an inside diameter of 0.775″, which will accomodate a 0.750″ decorative insert. The outside edge of the top of the 1.355″ diameter disc is chamfered 0.100×45 degrees to facilitate putting on and removal of the gas cap during the refueling operation.

The device can be mounted by using a bolt through the 0.250″ center hole or using a double-sided adhesive disc. The device is used during refueling a motorcycle at a service station as follows; park motorcycle next to gas pump, remove gas cap by unscrewing it from the gas tank, place the cap onto the invention holder, refuel motorcycle, remove gas cap from holder and screw back into gas tank.

1. I claim that this is a unique solution and use of a decorative and functional gas cap holder for a motorcycle, that the appearance and use of the article of manufacture for the stated purpose is both unique and very useful as a motorcycle accessory. the scope of this invention is intended to cover the use of any such item used for the purpose of holding, temporarily storing the gas cap of a motorcycle during its' removal for refueling.
